(19) United States
(12) Patent Application Publication
(10) Pub. No.: US 2007/0253592 A1
(43) Pub. Date: Nov. 1, 2007

(54) Method and System for Protecting and Authenticating a Digital Image

(76) Inventors: Qibin Sun, Singapore (SG); Zhishou Zhang, Singapore (SG); Dajun He, Singapore (SG)

Correspondence Address: Goodwin Procter, 599 Lexington Avenue, 23rd Fl., New York, NY, 10022, US

(21) Appl. No.: 10/573,220

(22) PCT Filed: Sep. 24, 2004
(86) PCT No.: PCT/SG04/00312

§ 371 Date: Feb. 27, 2007

Related U.S. Application Data
(60) Provisional application No. 60/506,315, filed on Sep. 26, 2003.

(51) Int. Cl. G06T 1/00

(52) U.S. Cl. 382/100

(57) ABSTRACT

A method of protecting a digital image, the method comprising extracting feature values from the digital image based on a selected authentication bit-rate; embedding data corresponding to the feature values as a watermark in a into the digital image; and creating an image signature based on the data corresponding to the feature values.

### FIELD OF INVENTION

The present invention relates broadly to a method and system for protecting a digital image, to a method and system for authenticating a digital image, to a computer readable data storage medium having stored thereon computer program code means for instructing a computer to execute a method of protecting a digital image, and to a computer readable data storage medium having stored thereon computer program code means for instructing a computer to execute a method of authenticating a digital image

### BACKGROUND

Stemmed from traditional cryptography, the requirements for preventing two kinds of frauds are usually expected for the purposes of content-based authentication. One is to prevent the forging from the recipient to make his attacks pass the authentication. The other is to prevent repudiation of the transmission of the content by the owner. Once you sign on it, you cannot deny it anymore. Based on these two requirements mentioned above, the state-of-art techniques for protecting images such as JPEG2000 images against unauthorized modifications can mainly be categorized into two classes: watermarking-based authentication and signature-based authentication.

Refer to FIG. 1, the watermarking-based solutions accomplish content authentication by embedding a noise-like signal 100 into the content 102 itself in an imperceptible way. The original content 102 may need to be transformed as well as the watermark 100 (embedding information). Usually a secret key 104 is used for making the embedding more secure. In the procedure of watermark extraction, by comparing the correlation results between the original content 102 and watermarked content 106, or practically, between the extracted watermark and that re-produced from keying the same watermark information as embedding, the authentication result can then be obtained even to locate the malicious manipulations. Fragile watermarking schemes perform well on authenticating images in terms of system security. Another advantage of watermarking-based solutions is its transparent storage property. However, when one needs to authenticate the images in a semi-fragile or robust way, the system security issue, although having been somehow addressed, is still far from the most of practical applications because watermarking always needs to balance between two vital system requirements: robustness and security.

Refer to FIG. 2, the signature-based solutions achieve the purposes of content authentication by modifying traditional cryptography algorithms from authenticating message to authenticating the content. After features 200 are extracted from the original content 202, usually hashing 204 is needed for security purpose as well as for storage concerns, the content owner can sign on them (hash 204) to form a signature 208 for the said content and then send the content 202 together with the signature 208 to the recipient. Later the recipient can show the authenticity of the content 212 to others by verifying the validity between the received signature 210 and that re-produced from the content 212 to be authenticated. Differing from watermarking-based solutions, signature-based solutions can adopt the well-known public key infrastructure (PKI) for practical applications. The main advantages of signature-based solutions are their well-proved security properties mentioned above. However, the security performance is also determined by the representation quality of extracted features 200 of the said content 202. For example, histogram and edge map may be important features in images, but if they are taken as extracted features for authentication, one can easily fake the images without changing their histogram and edge map. Another issue of signature-based solution is that they need an extra storage space.

In providing an authentication solution for e.g. JPEG2000, the following requirements may be considered: secure to prevent the two main attacks on image integrity and source verification, robust to tame some incidental distortions such as format conversion and transcoding, minimum or zero extra storage, etc. Another practical yet very important issue for authentication may be how to define the expected authentication strength for content.

### SUMMARY

In accordance with a first aspect of the present invention there is provided a method of protecting a digital image, the method comprising extracting feature values from the digital image based on a selected authentication bit-rate; embedding data corresponding to the feature values as a watermark into the digital image; and creating an image signature based on the data corresponding to the feature values.

The method may further comprise the step of selecting a desired authentication robustness level, and error correcting coding the extracted feature values prior to embedding the data corresponding to the feature values into the digital image.

The feature values from each of a plurality of codeblocks of the original digital image may be thresholded and coded to create the data corresponding to the feature values.

The coding of the thresholded feature values may comprise ECC coding to generate parity check bits (PCBs) as the data corresponding to the feature values.

The method may further comprise applying ECC coding again to the PCBs to generate the data corresponding to the feature values.

The creating of the image signature may comprise applying a cryptographic hashing function to a bit sequence representing the data corresponding to the feature values.

The creating of the image signature may comprise utilising a private key.

The method may further comprise distributing the digital image, including the embedded data, as the authentic digital image.

The method may further comprise coding the digital image, including the embedded data, utilising JPEG2000 compression.

The extracting of the feature values, the embedding of the data corresponding to the feature values, and the creating of the image signature may be performed as part of the JPEG 2000 coding.

In accordance with a second aspect of the present invention there is provided a method of authenticating a digital image, the method comprising extracting data embedded as a watermark in the digital image; extracting feature values from the digital image at a selected authentication bit-rate; processing the extracted data and extracted feature values to derive data corresponding to original feature values; and comparing the derived data corresponding to the original feature values with reference data derived from an image signature associated with the digital image.

The deriving of the data corresponding to the original feature values may comprise error correcting coding the extracted data and extracted feature values.

The extracted data and extracted feature values from each of a plurality of codeblocks of the digital image may be decoded to derive the data corresponding to the original feature values.

The extracted data may comprise PCBs, and the decoding of the extracted data and extracted feature values comprises ECC decoding.

The method may further comprise applying ECC decoding twice to the extracted data.

The method may further comprise applying a cryptographic technique to the image signature to derive a bit sequence representing the reference data.

The method may further comprise applying a public key to process the image signature for deriving the reference data.

The method may further comprise receiving the digital image as a coded digital image.

The digital image may be coded utilising JPEG2000.

The extracting of the data embedded as a watermark, the extracting of the feature values from the digital image, the processing of the extracted data and extracted feature values to derive data corresponding to original feature values, and the comparing of the derived data corresponding to the original feature values with the reference data may be performed as part of the JPEG 2000 de-coding.

In accordance with a third aspect of the present invention there is provided a system for protecting a digital image, the system comprising a feature value extractor device for extracting feature values from the digital image based on a selected authentication bit-rate; a watermarking device for embedding data corresponding to the feature values as a watermark into the digital image; and a processor device for creating an image signature based on the data corresponding to the feature values.

In accordance with a fourth aspect of the present invention there is provided a computer readable data storage medium having stored thereon computer program code means for instructing a computer to execute a method of protecting a digital image, the method comprising extracting feature values from the digital image based on a selected authentication bit-rate; embedding data corresponding to the feature values as a watermark into the digital image; and creating an image signature based on the data corresponding to the feature values.

In accordance with a fifth aspect of the present invention there is provided a system for authenticating a digital image, the system comprising an extraction device for extracting data embedded as a watermark in the digital image; a feature value extractor device for extracting feature values from the digital image based on a selected authentication bit-rate; a processor device for processing the extracted data and the extracted feature values to derive data corresponding to original feature values and for comparing the derived data corresponding to the original feature values with reference data derived from an image signature associated with the digital image.

In accordance with a sixth aspect of the present invention there is provided a computer readable data storage medium having stored thereon computer program code means for instructing a computer to execute a method of authenticating a digital image, the method comprising extracting data embedded as a watermark in the digital image; extracting feature values from the digital image based on a selected authentication bit-rate; processing the extracted data and extracted feature values to derive data corresponding to original feature values; and comparing the derived data corresponding to the original feature values with reference data derived from an image signature associated with the digital image.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 illustrates a prior art watermarking based authentication scheme.

FIG. 2 shows signature based authentication scheme.

FIG. 3 is a flow chart illustrating an image authentication process in accordance with an embodiment of the present invention.

FIG. 4 is a schematic drawing illustrating signature signing and watermark embedding process flow in accordance with an embodiment of the present invention.

FIG. 5 is a schematic drawing illustrating a watermark extracting and signature verification process flow in accordance with an embodiment of the present invention.

FIG. 6 is a flowchart illustrating a method of protecting a digital image in an example embodiment.

FIG. 7 is a flowchart illustrating a method of authenticating a digital image in an example embodiment.

FIG. 8 is a schematic drawing illustrating a computer system for implementing the method and system according to an embodiment of the present invention.

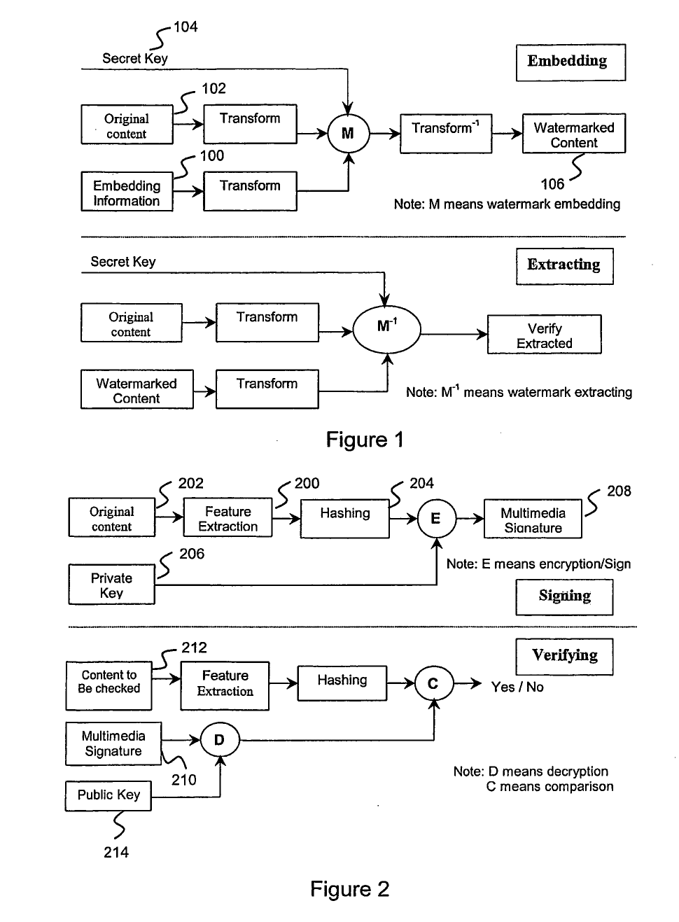

### DETAILED DESCRIPTION

A system and framework for authenticating JPEG2000 images in an example embodiment of the invention with a pre-specified authentication bit-rate (ABR) includes selecting ABR for the given image, selecting the desired authentication robustness level, encoding it according to the appropriate JPEG2000 procedure and parameters, generating the content-based signatures with the given ABR, watermarking error correction codes back to the given image, and sending the watermarked JPEG2000 image together with its digital signature to the recipient for future verification. The example embodiment is not only compatible with Public Key Infrastructure (PKI) but also robust and flexible in typical JPEG2000 image related operations such as lossless-to-lossy mode switching, multi-cycle compression and transcoding (truncation and parsing).

As mentioned above, one obstacle which affects current authentication systems is that it is very difficult to well define to what extent to authenticate the content If one needs to compress the content, several options to control the target compression quality such as either compression bit-rate, or target compressed file size in bytes or compression visual quality etc are typically given. It would be advantageous if similar functionalities are provided in the content authentication system. The example embodiment seeks to provide this functionality. It is worthy noting here that although the authentication could be also measured by quantization step size, because of a large diversity of content, furthermore, usually the content will be stored in compressed form which is done by both quantization and entropy coding, the quantization-based measure for authentication is still not well descriptive and explicit.

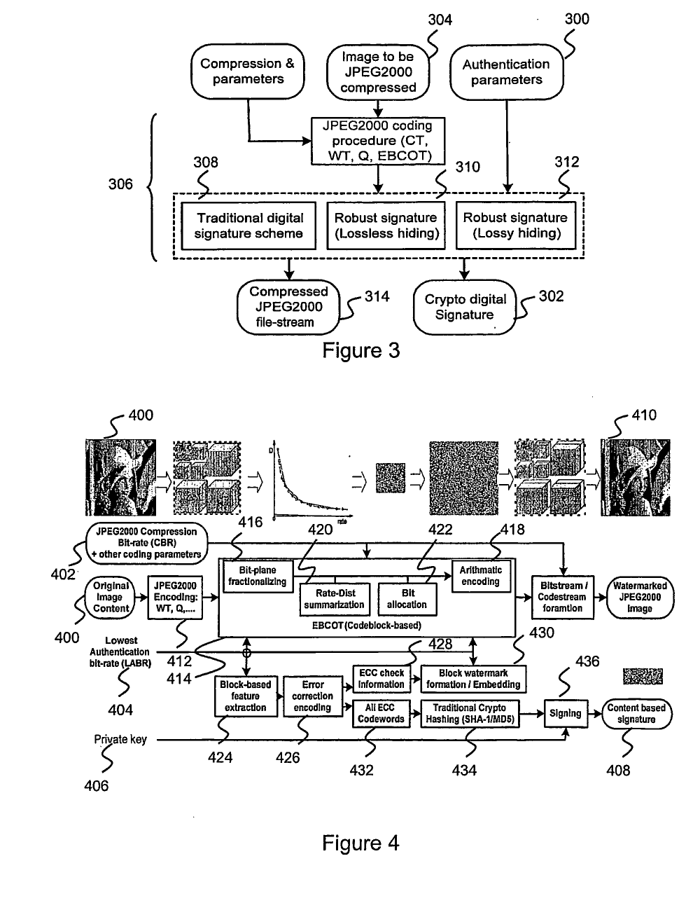

An authentication system in the example embodiment is illustrated in FIG. 3. Given a target authentication bit rate (ABR) and authentication robustness level (e.g., fragile, lossless to lossy) as parameter 300, one digital signature 302 is generated from the image content 304 during JPEG2000 coding procedure 306. By running EBCOT in an example embodiment, the whole protected content can be allocated in different subbands and different resolution levels based on the targeted ABR. If the required authentication robustness level is fragile, then a traditional signature module 308 is called to generate its corresponding signature (This is a straightforward solution of traditional crypto signature). If the required authentication robustness level is lossless, then a robust signature module 310 with lossless data hiding function is called so that after signature verification, the image content can be exactly recovered assuming no transcoding is applied. If transcoding has been applied to the image, the JPEG2000 image can still be verified but cannot be exactly recovered. If the required authentication robustness level is lossy, then a robust signature nodule 312 with lossy data hiding function is called to make the generated signature more robust to incidental distortions. The final outputs are a (watermarked) JPEG2000 image 314 and its associated digital signature 302.

The process for lossy semi-fragile content-based image authentication in the example embodiment will now be described. The lossless semi-fragile content-based image authentication in the example embodiment will not be described in detail, however, it will be appreciated by a person skilled in the art that those authentication are very similar, and instructions to implement one enables the person skilled in the art to implement the other. More specifically, lossy authentication utilises lossy watermarked embedding, whereas lossless authentication uses lossless watermarked embedding.

In the examples embodiment, signature generation/verification modules are mainly employed for content signing and authentication. Watermark embedding/extraction modules are only used for embedding and extracting ECC check information. Instead of directly sending an original image to recipients, only the watermarked copy is send together with one signed digital signature whose length is usually very short (the signature size is only around 1024 bits regardless of the original image size).

Refer to FIG. 4, among four inputs: original image 400, JPEG2000 compression bit-rate (CBR) 402b, Lowest authentication bit-rate 404 (LABR) a and image sender's private key 406, CBR 402 is the mandatory input for compressing images into JPEG2000 format. In addition to the original image 400, only two inputs are needed to generate the JPEG2000 image signature 408 in a content-based way: the private key 406 and the LABR 404a. If a JPEG2000 image signature is generated with LABR value a, a new image with CBR b will be authentic as long as b is greater than a and the new image is derived from defined acceptable manipulations or transcoded (by parsing or truncation) from a compressed JPEG2000 image 410. The original image 400 first undergoes color transformation, wavelet transformation and quantization, which are all basic procedures in JPEG2000 encoding 412. EBCOT 414 is then employed for bit plane fractionalizing/encoding 416, 418 and optimal bit rate control 420, 422. Content-based features are extracted 424 from the available fractionalized bit planes by assuming the image is encoded above LABR 404. Feature values from each codeblock are thresholded and ECC coded 426 to generate corresponding parity check bits (PCBs) 428. The PCBs are taken as the seed to form the block-based watermark 430.

The embedded watermark is preferably robust enough for extraction from received images under acceptable manipulations. Since incidental changes to the embedded watermarks might occur, ECC is applied in the examples embodiment again before the PCB data are embedded. The watermark data for each block are embedded into either the same block or a different block. The watermark embedding location may also be determined based on the LABR value 404. Note only the PCB data 428 (not including the feature codes) are embedded in the watermarking process of the example embodiment. All codewords 432 (features together with their corresponding PCBs) from all resolution levels and all subbands are concatenated and the resulting bit sequence is hashed by a cryptographic hashing function such as MD5 or SHA-1, 434. The generated semi-fragile hash value can then be signed 436 using the content sender's private key 406 to form the crypto signature 408. Differing from a data-based signature scheme in which the original data are sent to the recipients associated with its signature, in the example embodiment the watermarked image is send to the recipients instead of sending the original image 400.

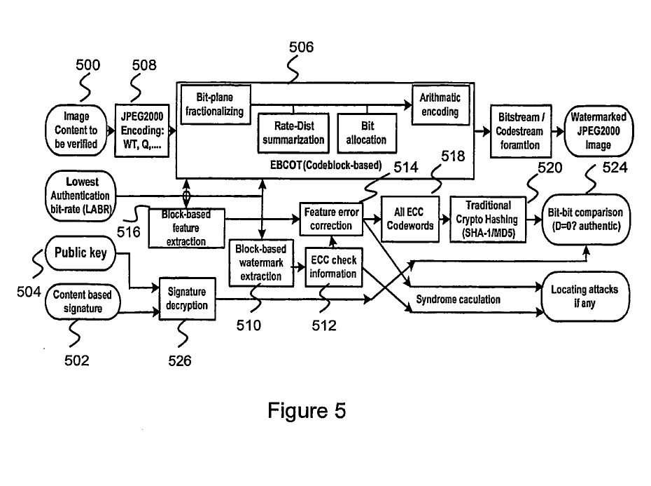

Refer to FIG. 5. To authenticate received image content 500, in addition to the image itself, two other pieces of information are needed in the example embodiment: the signature 502 associated with the image 500 (transmitted through external channels or as embedded watermarks), and the content sender's public key 504. The image 500 is processed in the same way as content signing: decompose and quantize image into blocks, to extract features for each block. (Note that here it is assumed the JPEG2000 image has been decoded into raw image and one is authenticating this raw image given LABR. If the image is still JPEG2000 compressed, the features and watermarks can also be obtained in the EBCOT domain from the JPEG2000 decoding procedure). From those embedded watermarks 510, one extracts the PCB data generated at the source site 512. Note that the features are computed 516 from the received image 500, while the PCBs are recovered from the watermarks 510 that are generated and embedded at the source site. After we combine the features and the corresponding PCBs to form codewords 518 the whole content verification decision can be made.

First, calculate the syndrome of the codeword block by block to see whether any blocks exist whose codewords are uncorrectable. If yes, then we claim the image is unauthentic and use the above ECC checking process to display alteration locations. If all codewords are correctable (i.e. errors in any feature code are correctable by its PCB), we repeat the same process as the source site: concatenate all corrected codewords into a global sequence and cryptographically hash 520 the result sequence. The final verification result is then concluded through a bit-by-bit comparison 524 between these two hashed sets (i.e., one is this new generated and the other is decrypted 526 from the associated signature 502 by the obtained public key 504): if any single bit differs, the verifier will deem the image unacceptable (“unauthentic”).

The procedure of signature generation and watermark embedding in the example embodiment involves:

Selecting the authentication robustness levels: fragile, semi-fragile with lossless data hiding and semi-fragile with lossy data hiding.

JPEG2000 encoding the image based on coding parameters such as progression order, compression bit-rate, etc.

Generating the content-based features with the given Authentication Bit-Rate (ABR).

Employing error correcting coding scheme to tame the feature perturbations caused by some incidental noises or embedded watermarks, if semi-fragile authentication is selected.

Embedding the PCBs of all ECC codewords back to the image as watermarks. Here, either lossy or lossless embedding is utilised, depending on whether semi-fragile lossless or lossy data hiding is chosen as the authentication robustness level.

Applying crypto hash on all ECC codewords.

Using image owner's private key to sign on the hash value and obtain the image signature.

The procedure of watermark extraction and signature verification in the example embodiment involves:

Selecting the authentication robustness levels: fragile, semi-fragile with lossless data hiding and semi-fragile with lossy data hiding.

Generating the content-based features with the given authentication bit-rate from the decoded JPEG2000 image or encoding JPEG2000 image.

Extracting the said watermarks from the image content. If the watermarking is lossless and no truncation is applied into JPEG2000 image, recover the JPEG2000 image if necessary.

Employing error correcting coding scheme on the generated features and extracted watermarks. If ECC fails, indicate the locations as possible attacks. Otherwise Applying crypto hash on all ECC codewords.

Decrypting the associated image signature and obtain another set of hash

Bit-bit comparison between these two hashes: if one bit difference exists, the image is deemed as unauthentic.

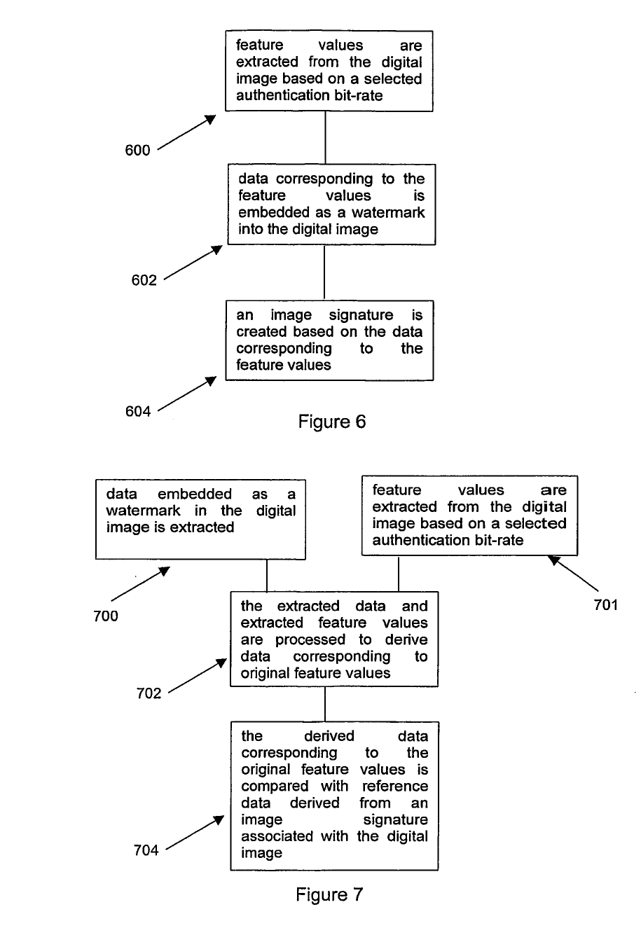

FIG. 6 is a flowchart illustrating a method of protecting a digital image in an example embodiment. At step 600, feature values are extracted from the digital image based on a selected authentication bit-rate. At step 602, data corresponding to the feature values is embedded as a watermark into the digital image, and at step 604 an image signature is created based on the data corresponding to the feature values.

FIG. 7 is a flowchart illustrating a method of authenticating a digital image in an example embodiment. At step 700, data embedded as a watermark in the digital image is extracted. At step 701, feature values are extracted from the digital image based on a selected authentication bit-rate. At step 702, the extracted data and extracted feature values are processed to derive data corresponding to original feature values, and at step 704, the derived data corresponding to the original feature values is compared with reference data derived from an image signature associated with the digital image.

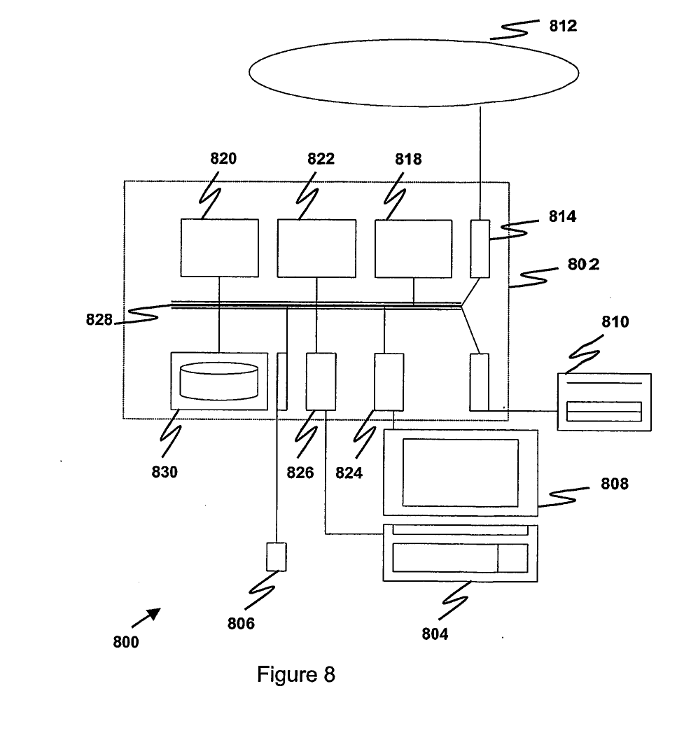

The method and system of the example embodiment can be implemented on a computer system 800, schematically shown in FIG. 8. It may be implemented as software, such as a computer program being executed within the computer system 800, and instructing the computer system 800 to conduct the method of the example embodiment.

The computer system 800 comprises a computer module 802, input modules such as a keyboard 804 and mouse 806 and a plurality of output devices such as a display 808, and printer 810.

The computer module 802 is connected to a computer network 812 via a suitable transceiver device 814, to enable access to e.g. the Internet or other network systems such as Local Area Network (LAN) or Wide Area Network (WAN).

The computer module 802 in the example includes a processor 818, a Random Access Memory (RAM) 820 and a Read Only Memory (ROM) 822. The computer module 802 also includes a number of Input/Output (I/O) interfaces, for example I/O interface 824 to the display 808, and I/O interface 826 to the keyboard 804.

The components of the computer module 802 typically communicate via and interconnected bus 828 and in a manner known to the person skilled in the relevant art.

The application program is typically supplied to the user of the computer system 800 encoded on a data storage medium such as a CD-ROM or floppy disk and read utilising a corresponding data storage medium drive of a data storage device 830. The application program is read and controlled in its execution by the processor 818. Intermediate storage of program data maybe accomplished using RAM 820.

The embodiment described may provide a system and method for content-based authentication against unauthorized modifications of the JPEG2000.

A system and method for authenticating JPEG2000 image in the embodiment described includes: selecting ABR for the given image, selecting the desired authentication robustness level, encoding it according to the appropriate JPEG2000 procedure and parameters, generating the content-based signatures with the given ABR, watermarking error correction codes back to the given image, finally sending the watermarked JPEG2000 image associated with its digital signature to the recipient for future verification.

Typical applications of the authentication framework of the embodiment described include, but are not limited to:

Content streaming: Protecting the integrity of the streamed content under given authentication bit-rate. The streaming could be done in several ways such as streaming the content into a buffer with bit-rate A later streaming it into the client with bit-rate B. As long as the all streamed bit-rates in terms of the original file size are greater than the said authentication bit-rate, the streamed content should be protected against unauthorized modifications.

Content transformation in different domains: Given the authentication bit-rate, the content to be protected may undergo some practical transformations among different domains such as digital-to-analog and analog-to-digital. By using ECC scheme, the transformed content should be protected against unauthorized modifications as long as the bit-rate of transformed content is still greater than authentication bit-rate.

Embodiments of the invention may provide a systematic and quantitative way for authenticating multimedia content by casting the content into a finer representation in terms of ABR. This then brings much convenience for the authentication applications by simply keying in one parameter-authentication bit-rate to protect the content.

Embodiments of the invention may also provide a framework for meeting different authentication requirements from real applications by employing different signing modules (fragile, lossless and lossy) which is in line with different JPEG2000 coding settings.

Embodiments of the invention may also provide an ECC-based solution for tackling the perturbation problem of extracted features caused by some incidental distortions as well as watermarking. Furthermore, the invention can be incorporated into PKI without any modifications in terms of system protocols.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1-24. (canceled)

25. A method of protecting a digital image, the method comprising:
extracting feature values from the digital image based on a selected authentication bit-rate and a selected image content;
selecting an authentication mode for processing the extracted feature values, the processing of the extracted feature values comprising deriving data corresponding to the extracted feature values based on the selected authentication mode; and
creating an image signature based on the data corresponding to the feature values.

26. The method as claimed in claim 25, wherein the processing comprises correcting coding (ECC) the extracted feature values to derive the data corresponding to the feature values.

27. The method as claimed in claim 25, wherein the feature values from each of a plurality of codeblocks of the original digital image are thresholded and coded to create the data corresponding to the feature values.

28. The method as claimed in any one of claim 25, wherein the processing further comprises embedding the data corresponding to the feature values into the digital image.

29. The method as claimed in claim 26, further comprising applying ECC coding again to parity check bits generated during the ECC coding of the extracted feature values to generate the data corresponding to the feature values.

30. The method as claimed in claim 28, wherein the embedding of the data corresponding to the feature values as a watermark is conducted in a lossy or a lossless way, based on the selected authentication mode.

31. The method as claimed in any one of claim 25, wherein the creating of the image signature comprises applying a cryptographic hashing function to a bit sequence representing the data corresponding to the feature values.

32. The method as claimed in any one of claim 25, wherein the creating of the image signature comprises utilising a private key.

33. The method as claimed in any one of claim 25, wherein the method further comprises distributing the digital image, including the embedded data, as the authentic digital image.

34. The method as claimed in any one of claim 25, further comprising coding the digital image, including the embedded data, utilising JPEG2000 compression.

35. The method as claimed in claim 34, wherein the extracting of the feature values, the embedding of the data corresponding to the feature values, and the creating of the image signature are performed as part of the JPEG 2000 coding.

36. A method of authenticating a digital image, the method comprising:
extracting feature values from the digital image based on a selected authentication bit-rate; and
processing the extracted feature values to derive data corresponding to original feature values based on a selected authentication mode; and
comparing the derived data corresponding to the original feature values with reference data derived from an image signature associated with the digital image.

37. The method as claimed in claim 36, wherein deriving the data corresponding to the feature values comprises ECC coding the extracted data and extracted feature values.

38. The method as claimed in claim 36, wherein the extracted feature values from each of a plurality of codeblocks of the digital image are decoded to derive the data corresponding to the original feature values.

39. The method as claimed in any one of claim 36, further comprising extracting data embedded as a watermark in the digital image; and the processing the extracted data and the extracted feature values to derive the data corresponding to original feature values.

40. The method as claimed in claim 37, further comprising applying ECC decoding twice to the extracted data.

41. The method as claimed in claim 35, wherein the data is embedded in a lossy or lossless way as a watermark in the digital image.

42. The method as claimed in any one of claim 36, further comprising applying a cryptographic technique to the image signature to derive a bit sequence representing the reference data.

43. The method as claimed in any one of claim 36, further comprising applying a public key to process the image signature for deriving the reference data.

44. The method as claimed in any one of claim 36, wherein the method further comprises receiving the digital image as a coded digital image.

45. The method as claimed in claim 44, wherein the digital image is coded utilising JPEG2000.

46. The method as claimed in claim 36, wherein the extracting of the data embedded as a watermark, the extracting of feature values from the digital image, the processing of the extracted data and extracted feature values, and the comparing of the derived data corresponding to the original feature values with the reference data are performed as part of the JPEG 2000 de-coding.

47. A system for protecting a digital image, the system comprising:
a feature value extractor device for extracting feature values from the digital image based on a selected authentication bit-rate;
a mode selector for selecting an authentication mode for processing the extracted feature values;
a processor device for deriving data corresponding to the extracted feature values based on the selected authentication mode; and
wherein the processor device further creates an image signature based on the data corresponding to the feature values.

48. A computer readable data storage medium having stored thereon computer program code means for instructing a computer to execute a method of protecting a digital image, the method comprising:
extracting feature values from the digital image based on a selected authentication bit-rate;
selecting an authentication mode for processing the extracted feature values, the processing of the extracted feature values comprising deriving data corresponding to the extracted feature values based on the selected authentication mode; and
creating an image signature based on the data corresponding to the feature values.

49. A system for authenticating a digital image, the system comprising:
a feature value extractor device for extracting feature values from the digital image based on a selected authentication bit-rate;
a processor device for processing the extracted feature values based on a selected authentication mode to derive data corresponding to original feature values and for comparing the derived data corresponding to the original feature values with reference data derived from an image signature associated with the digital image.

50. A computer readable data storage medium having stored thereon computer program code means for instructing a computer to execute a method of authenticating a digital image, the method comprising:
extracting feature values from the digital image based on a selected authentication bit-rate;
processing the extracted feature values based on a selected authentication mode to derive data corresponding to original feature values; and
comparing the derived data corresponding to the original feature values with reference data derived from an image signature associated with the digital image.
